(19) United States
(12) Patent Application Publication
(10) Pub. No.: US 2020/0282387 A1
(43) Pub. Date: Sep. 10, 2020

(54) LINEAR TITANIUM-OXIDE POLYMER, TITANIUM DIOXIDE COATING, PHOTOCATALYTIC COATING AND PREPARATION METHOD THEREFOR

(71) Applicant: Beijing Huatai Technology Company LTD, Beijing (CN)

(72) Inventors: Yuzhan LI, Beijing (CN); Hua WANG, Beijing (CN); Anyang BAI, Beijing (CN); Xin YUAN, Beijing (CN); Jiangfeng FAN, Beijing (CN)

(73) Assignee: Beijing Huatai Technology Company LTD, Beijing (CN)

(21) Appl. No.: 16/086,004

(22) PCT Filed: Mar. 17, 2017
(86) PCT No.: PCT/CN2017/077068

§ 371 Date: Sep. 17, 2018

(30) Foreign Application Priority Data
Mar. 18, 2016 (CN) 201610157770.6
Apr. 28, 2016 (CN) 201610273985.4
Apr. 28, 2016 (CN) 201610274821.3

(51) Int. Cl. B01J 35/00; C08G 79/00; B01J 21/06; B01J 21/08; B01J 21/02; B01J 23/755; B01J 37/08; B01J 37/02

(52) U.S. Cl. CPC B01J 35/004; C08G 79/00; B01J 21/063; B01J 21/08; B01J 37/0219; B01J 23/755; B01J 35/0013; B01J 37/086; B01J 21/02

(57) ABSTRACT

A linear titanium-oxide polymer, a nano-TiO₂ coating structure, a glass fiber mat-nano-TiO₂ photocatalytic coating structure and methods for preparing the same are disclosed. The linear titanium-oxide polymer has the following structural formula:

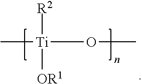

The prepared materials can be used for photocatalysis, deodorizing filters, antibacterial filters, indoor air purifying filters, transport vehicle purifying filters, and household appliance purifiers and so on.

### CROSS REFERENCE TO RELATED APPLICATIONS

This application is the national phase entry of International Application No. PCT/CN2017/077068, filed on Mar. 17, 2017, which is based upon and claims priority to Chinese Patent Applications No. 201610157770.6, filed on Mar. 18, 2016, No. 201610273985.4, filed on Apr. 28, 2016, and No. 201610274821.3, filed on Apr. 28, 2016, the entire contents of which are incorporated herein by reference.

### TECHNICAL FIELD

The present invention relates to the field of functional materials, and more particularly to a linear titanium-oxide polymer, titanium dioxide coating, photocatalytic coating, and methods for preparing the same.

### BACKGROUND

In recent years, with the acceleration of the global industrialization process, environmental pollution problems have become increasingly serious, and the environmental treatment has received extensive attention from countries around the world, wherein the government has invested enormous human, material and financial resources in environmental treatment to support the research and industrialization of environmental purification materials and environmental purification technologies, among which, photocatalytic materials and photocatalytic technologies play an important role. TiO₂ is a commonly used photocatalyst advantaged in high activity, good stability, and almost oxidizing the organic substances without selectivity, producing no secondary pollution, harmless to the human body and low price, which makes it become the most important photocatalyst with broad application prospects.

The nano-TiO₂ photocatalyst prepared by a sol-gel method has the advantages of small particle size, high purity, good monodispersity, easy to control the reaction and less side reaction and so on. However, the interaction between the colloidal particles is particularly large when the sol is converted into a gel, which results in some problems during the sintering process, for example, agglomeration is prone to occur, and photocatalytic properties are easily affected. In addition, although preparation of a thin film photocatalyst by the sol-gel method has the advantages of easy to load, good fastness, simple process equipment, low cost and so on, the film prepared by the sol-gel method has the following disadvantages: easy to crack during the drying process, which objectively limits the thickness of the resulting film; limited loading capacity, leading to low quantum efficiency and poor catalytic activity; and slow purification for air and sewage, which cannot meet the needs of practical applications. Thus, it can be seen that the TiO₂ photocatalyst faces two technical difficulties in application: one is to obtain the TiO₂ powder with a high catalytic activity, and the other is to obtain large TiO₂ loading capacity. Therefore, it is an urgent problem to improve the photocatalytic performance and loading capacity of TiO₂, and achieve a strong bonding to the carrier, thereby ensuring that TiO₂ is not easily detached from the carrier during use.

There are three main methods for preparing a TiO₂-loading photocatalyst: the first method is to prepare a TiO₂ thin film directly on the surface of a substrate by the sol-gel method, followed by heat treatment; the second method is to disperse the nano-TiO₂ powder directly into a suspension, and load it onto the surface of the substrate, followed by heat treatment, which method is not used commonly; and the third method is to load the nano-TiO₂ photocatalystonto the surface of the substrate by using inorganic and organic binders, followed by heat treatment.

The above three methods for preparing a TiO₂-loading photocatalyst have their own shortcomings. In the first method, a TiO₂ thin film is prepared by the sol-gel method, and the method is characterized in that the thin film has a non-porous structure, with small specific surface area and poor activity. For the photocatalyst prepared by the second method, since TiO₂ is bound to the carrier loosely, the photocatalyst is easy to detach from the carrier, which makes it difficult to be applied in practice. With regard to the TiO₂ photocatalyst prepared by the third method, it has low photocatalytic efficiency due to the coating effect of the inorganic and organic binders on the nano-TiO₂ photocatalyst.

The nano-TiO₂ photocatalyst has a variety of functions, which makes its application be extended to several frontier application fields. However, there are still certain problems in the practical application of the nano-TiO₂-loading photocatalyst.

In addition, in the prior art, the binders (organic or inorganic binders), in particularly the inorganic silica sol binders are often used to immobilize the nano-TiO₂ on the carriers. This method has the advantages of simple operation, strong adhesion to a catalyst and so on, however, since the photocatalyst on the surface of the substrate is in the form of the coating bonded by the binder, the nano-TiO₂ in the resulting coating is in a state of serious aggregation, and the binder may be coated on the surface of the nano-TiO₂ particles, which greatly reduces the photocatalytic effect of the TiO₂ material.

### SUMMARY

The objects of the present invention are to provide a linear titanium-oxide polymer, a method for preparing the same and its use for preparation of a porous nano-TiO₂ photocatalyst.

In the context of the present invention, the term “linear titanium-oxide polymer” refers to an organometallic polymer having a main chain structure of Ti—O—Ti (with repeating Ti—O bonds as the main chain) and an organic group attached to a pendant group, which is prepared by the coordination protection, controlled hydrolysis and high temperature poly condensation reaction of a titanate (Ti(OR¹)₄). The linear titanium-oxide polymer of the present invention, as a source of TiO₂, has the processing characteristics of an organic polymer, and is easily soluble in one or more solvents, such as monohydric alcohols or dihydric alcohols having 2-5 carbon atoms, ethylene glycol monoethers having 3-8 carbon atoms, toluene or xylene. When the linear titanium-oxide polymer of the present invention is dispersed in a solvent, it can be used as a surface modifier to make the solution possess a good film-forming property, and can improve the adhesion of the coating to the substrate. The porous nano-TiO₂ photocatalyst which is prepared by sintering the linear titanium-oxide polymer of the present invention not only solves the problem of poor photocatalytic performance caused by the agglomeration of the TiO₂ powder prepared by a sol-gel method, but also overcomes the disadvantages of less TiO₂ loading capacity and weak bonding to TiO₂. This is because the resulting TiO₂ materials have a porous structure with a large specific surface area, which lays the foundation for its application in the field of photocatalysis.

In one aspect, the present invention provides a linear titanium-oxide polymer having the following structure:

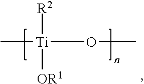

wherein R¹ is independently selected from the group consisting of —C₂H₅, —C₃H₇, —C₄H₉, and —C₅H₁₁; R² represents OR¹ or represents a complexing group selected from the group consisting of CH₃COCHCOCH₃ and CH₃COCHCOOC₂H₅, provided that at least 50% of the R² groups represent the complexing group by the total number of the R² groups; the number average molecular weight (Mn) of the titanium-oxide polymer is 2000-3000 as determined by vapor-pressure osmometry; and the solvent-free pure titanium-oxide polymer has a softening point in the range of 90-127° C. as determined by the ring-and-ball method.

The vapor-pressure osmometry is a method for determining the number average molecular weight of a solute, and is commonly used to determine the molecular weight of a macromolecular compound, the principle of which is based on Raoult's law of ideal solution. The method is implemented by using a parameter, and the specific operation is as follows: 20 ml of a solvent is added to a measuring cell, then the instrument is installed and preheated, and zero setting is performed after the display shows a constant value, so as to make the instrument have the conditions to analyze the sample. A standard sample and specimen are prepared using an analytical balance, and completely dissolved to be tested. The solutions of the above standard sample and specimen are taken and placed in a test hole, and preheated for 5 min, then the original solvent on the test probe is replaced with the prepared solution. The response switch is started, and the output signal value ΔG is read after the red light flashes. The parameters K_{correction} and Kₘₑₐₛᵤᵣₑₘₑₙₜ are calculated, and the parameter K is calculated according to the following equation: K=ΔG/c, wherein ΔG represents the signal value showed by the measured standard sample; and represents the mass concentrations of the standard sample and specimen solutions. Finally the number average molecular weight (Mn) is calculated according to the following equation: Mn=K_{correction}/Kₘₑₐₛᵤᵣₑₘₑₙₜ.

The softening point mainly refers to the temperature at which the amorphous polymer begins to soften, which is tested according to National Quality Supervision, Inspection and Quarantine Standard “GB/T 4507-2014 Method for determining the softening point of asphalt (ring-and-ball method)”.

As a preferred embodiment of the above technical solutions, the linear titanium-oxide polymer of the present invention is soluble in any one or more of solvents selected from the group consisting of monohydric alcohol sordihydric alcohols having 2-5 carbon atoms, ethylene glycol monoethers having 3-8 carbon atoms with a low boiling point, toluene or xylene.

In the present invention, the titanium-oxide polymer is soluble in a common solvent, which expands the application range of the titanium-oxide polymer.

In another aspect, the present invention provides a method for preparing the linear titanium-oxide polymer, comprising the steps of:

1) adding titanate to a reaction vessel, and adding a chelating agent at 50-90° C., followed by heating and stirring for 0.5-1.5 h;

2) adding a mixed solution of water and alcohol dropwise at 50-90° C., and stirring at 80-110° C. for 1.5-4 h after the addition is completed, cooling the mixture and then removing the solvent under reduced pressure to obtain the titanium-oxide polymer.

In the present invention, firstly a titanate is added to a reaction vessel, and a chelating agent is added at 50-90° C., followed by heating and stirring for 0.5-1.5 h; after the first step is completed, a mixed solution of water and alcohol is added dropwise at 50-90° C. slowly, and the mixture is stirred at 80-110° C. for 1.5-4 h after the addition is completed; the mixture is cooled, and then the solvent is removed under reduced pressure to obtain the titanium-oxide polymer.

The titanium-oxide polymer prepared by the method of the present invention is an organic macromolecule polymer with the processing property of an organic polymer and can be dissolved in a common solvent; and can be used as a surface modifier in a solution, which improves the adhesion of the solution to the substrate. This solves not only the problem of poor catalytic performance caused by the easy agglomeration of the powder, but also the problem of less loading capacity and weak bonding.

In one preferred embodiment of the present invention, the molar ratio of the titanate, the chelating agent and water is 1:(0.5-1.4):(0.8-1.3).

In one preferred embodiment of the present invention, the molar ratio of water to alcohol in the mixed solution of water and alcohol is 1:(3-20).

In one preferred embodiment of the present invention, in step 1), the titanate has a structure of Ti(OR¹)₄, wherein R¹ is independently selected from an alkyl group having 2-5 carbon atoms.

In one preferred embodiment of the present invention, in step 1), the chelating agent is selected from one or both of acetylacetone and ethyl acetoacetate.

In one preferred embodiment of the present invention, in the mixed solution of water and alcohol in step 2), the alcohol is selected from one or more of monohydric alcohols having 2-5 carbon atoms.

When the molar ratio of the titanate, the chelating agent and water is not selected properly, a soluble titanium-oxide polymer cannot be obtained, and the precipitation may occur during the reaction. In the present invention, the molar ratio of the titanate, the chelating agent and water is determined to be 1:(0.5-1.4):(0.8-1.3) through a large number of experiments. So long as the molar ratio is within the above range, a soluble titanium-oxide polymer can be obtained.

In one preferred embodiment of the present invention, the titanate Ti(OR¹)₄ is a highly reactive molecule with four functional groups. Firstly it undergoes a coordination reaction with a chelating agent such as acetylacetone, then a hydrolysis reaction of the titanate, followed by a poly condensation reaction that requires to be conducted at a certain temperature. In order to obtain the linear titanium-oxide polymer, water is added dropwise slowly at a certain temperature in the step of hydrolysis of the titanate, and the titanate is hydrolyzed rapidly after the low concentration of water molecules enter the reaction system. Since the reaction system is maintained at a high temperature, the titanium hydroxyl group formed by the hydrolysis immediately undergoes a polycondensation reaction to form a structure of Ti—O—Ti. In order to effectively reduce the rate at which water is introduced into the reaction system, preferably a mixture of water and alcohol is added dropwise, and also the molar ratio of the titanate to water is made to be 0.8-1.3, such that more titanium alkoxy groups are retained to ensure the good performance of the linear titanium-oxide polymer.

In still another aspect, the present invention also provides the use of the linear titanium-oxide polymer for the preparation of a porous nano-TiO₂ photocatalyst.

Specifically, the titanium-oxide polymer of the present invention is sintered in air at 400-600° C. to obtain the porous nano-TiO₂ photocatalyst.

Compared with the prior art, the present invention has the following advantages:

in the prior art, the TiO₂ photocatalyst is generally prepared by the sol-gel method, and there are problems of easy agglomeration of the powder, less loading capacity and weak bonding, which severely limit the application of the TiO₂ photocatalyst in practical. The beneficial effects of the present invention lies in that the prepared linear titanium-oxide polymer can be dispersed in an organic solvent at a molecular level, and the porous nano-TiO₂ photocatalyst can be obtained by the pyrolysis of the titanium-oxide polymer. The experiment shows that the porous nano-TiO₂ photocatalyst has good degradation capability to methyl orange under ultraviolet light.

The present invention also provides a nano-TiO₂ coating structure comprising a substrate and a nano-TiO₂ coating supported on the surface of the substrate, wherein the nano-TiO₂ coating comprises nano-TiO₂ particles having an average particle size of 10-50 nm, and the loading capacity of the nano-TiO₂ coating is 1.0-100 g TiO₂ per cm² of the substrate.

In the nano-TiO₂ coating structure of the present invention, each nano-TiO₂ particle in the nano-TiO₂ coating is composed of basic particles or microcrystalline clusters having a diameter of 2-5 nm.

In the nano-TiO₂ coating structure of the present invention, the thickness of the nano-TiO₂ coating is preferably 10-500 nm, more preferably 50-200 nm, and most preferably 80-150 nm.

In the nano-TiO₂ coating structure of the present invention, the thickness of the nano-TiO₂ coating corresponds to a TiO₂ loading capacity of 1.0-100 g of TiO₂ per cm² of the substrate, preferably about 1.0-3 g of TiO₂ per cm² of the substrate, more preferably about 1.0-1.5 g of TiO₂ per cm² of the substrate.

In the nano-TiO₂ coating structure of the present invention, the TiO₂ in the nano-TiO₂ coating is of anatase phase, which can initiate a photocatalytic reaction under excitation of ultraviolet light. The TiO₂ of anatase phase exhibits high catalytic activity, but when the TiO₂ of rutile phase is present, the catalytic activity is reduced. In addition, the super-hydrophilic reaction of the nano-TiO₂ coating also can be induced under excitation of ultraviolet light.

In the nano-TiO₂ coating structure of the present invention, the nano-TiO₂ coating is colorless and/or transparent. The colorless and/or transparent coating has a high light transmittance, such that the ultraviolet light and visible light can pass through it effectively.

The visible light transmittance of the nano-TiO₂ coating structure of the present invention is preferably above 80%, more preferably above 90%.

The water contact angle of the nano-TiO₂ coating structure of the present invention is preferably less than 100, more preferably less than 50 In the nano-TiO₂ coating structure of the present invention, the shape of the nano-TiO₂ coating can vary with the shape of the substrate, for example, a plane or a curved surface, a sphere or any hollow three-dimensional shape, thus this nano-TiO₂ coating has excellent adaptability and compatibility.

In the nano-TiO₂ coating structure of the present invention, the substrate may be in any shape, for example in the shape of a plate, a honeycomb, a fiber, a sphere or a hollow sphere.

The substrate includes, but is not limited to, silicon-based materials, metals, glass, ceramics, adsorbent materials, or any combination thereof. In some embodiments of the present invention, the examples of the metal substrate include steel plates, aluminum plates, titanium plates, copper plates, zinc plates, foamed nickels, foamed aluminums, aluminum honeycombs, and the like; the examples of the glass substrate include glass sheets, glass fibers, hollow glass microspheres, glass beads, glass springs, and the like; the examples of the ceramic substrate include hollow ceramic microspheres, ceramic tiles, ceramic plates, honeycomb ceramics, and the like; the examples of the adsorbent material substrate include silicon oxide, silica gels, activated carbons, zeolites, molecular sieves, and the like. The substrate of the present invention may also be selected from other materials, such as cements, quartz sands, expanded perlites, firebrick particles, wood chips, organic polymers, fabrics, and the like, and is not limited to the substrate exemplified above.

In the nano-TiO₂ coating structure of the present invention, the surface of the substrate is preferably rough, with outer surfaces of protrusions and/or potholes of nanoscale size. The outer surface with a roughness of nanometer scale can enhance the adhesion of the nano-TiO₂ coating to the substrate.

The present invention also provides a method for preparing thenano-TiO₂ coating structure, comprising the steps of:

1) dissolving the linear titanium-oxide polymer in a solvent to prepare a solution, wherein the concentration of the solution is 0.3-2 wt % by titanium;

2) pretreating the surface of the substrate to be coated optionally;

3) coating the prepared linear titanium-oxide polymer solution uniformly on the substrate, followed by drying and sintering, to obtain the nano-TiO₂ coating.

In the method for preparing the nano-TiO₂ coating structure in the present invention, the linear titanium-oxide polymer described in step 1) is a linear titanium-oxide polymer with repeating Ti—O bonds as the main chain and an organic group attached to a pendant group, and comprises the following structure formula:

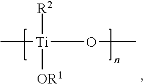

wherein R¹ is independently selected from the group consisting of —C₂H₅, —C₃H₇, —C₄H₉, and —C₅H₁₁; R² represents OR¹ or represents a complexing group selected from the group consisting of CH₃COCHCOCH₃ and CH₃COCHCOOC₂H₅, provided that at least 50% of the R² groups represent the complexing group by the total number of the R² groups; the number average molecular weight (Mn) of the titanium-oxide polymer is 2000-3000 as determined by vapor-pressure osmometry; and the solvent-free pure titanium-oxide polymer has a softening point in the range of 90−127° C. as determined by the ring-and-ball method.

Preferably, the linear titanium-oxide polymer is soluble in one or more of solvents selected from the group consisting of monohydric alcohols or dihydric alcohols having 2-5 carbon atoms, ethylene glycol monoethers having 3-8 carbon atoms, toluene or xylene.

Preferably, the linear titanium-oxide used in the present invention is prepared by the method comprising the steps of:

1) adding a titanate to a reaction vessel, and adding a chelating agent at 50-90° C., followed by heating and stirring for 0.5-5.0 h;

2) adding a mixed solution of water and alcohol dropwise at 50-90° C., and stirring at 80-110° C. for 1.5-6 h after the addition is completed, cooling the mixture and then removing the solvent under reduced pressure to obtain the titanium-oxide polymer.

In the method for preparing the linear titanium-oxide in the present invention, the titanate preferably has the structure of Ti(OR¹)₄, wherein R¹ is independently selected from the group consisting of —C₂H₅, —C₃H₇, —C₄H₉ and —C₅H₁₁. Preferably the titanate is tetrabutyl titanate.

In the method for preparing the linear titanium-oxide in the present invention, the chelating agent is preferably selected from one or both of acetylacetone and ethyl acetoacetate.

In the method for preparing the linear titanium-oxide in the present invention, the molar ratio of the titanate, the chelating agent and water is preferably 1:(0.5-1.4):(0.8-1.3).

In the method for preparing the linear titanium-oxide in the present invention, the alcohol in the mixed solution of water and alcohol is preferably selected from one or more of monohydric alcohols having 2-5 carbon atoms, and the molar ratio of water to alcohol in the mixed solution of water and alcohol is preferably 1:(3-20).

The linear titanium-oxide polymer prepared in the present invention can be used as a source of nano-TiO₂, and also can be used as a surface modifier. It can be dispersed in an organic solvent at a molecular level, and has a good film-forming property and thus can increase the adhesion of the coating to different substrates. In the prior art, the TiO₂ photocatalyst is prepared by the sol-gel method, and there are problems of easy agglomeration of the powder, less loading capacity, and weak bonding, which severely limit the application of the TiO₂ photocatalyst in practical, as described in “BACKGROUND”. The linear titanium-oxide polymer prepared in the present invention can be used to coat the substrate material, and be pyrolized to obtain the nano-TiO₂ coating structure, and the obtained coating is uniform and has an increased loading capacity of TiO₂ and improved adhesion to the substrate, thereby overcoming the disadvantages of the prior art.

In the method for preparing the nano-TiO₂ coating structure in the present invention, the solvent in step 1) preferably comprises one or more of monohydric alcohols or dihydric alcohols having 2-5 carbon atoms, methyl ethers having 3-8 carbon atoms with low boiling point, toluene or xylene. The concentration of the linear titanium-oxide polymer solution is preferably 0.1-3 wt %, more preferably 0.3-2 wt % by titanium.

In the method for preparing the nano-TiO₂ coating structure in the present invention, the substrate to be coated in step 2) may be in any shape, for example in the shape of a plate, a honeycomb, a fiber, a sphere or a hollow sphere.

The substrate includes, but is not limited to, silicon-based materials, metals, glass, ceramics, adsorbent materials, or any combination thereof. In some embodiments of the present invention, the examples of the metal substrate include steel plates, aluminum plates, titanium plates, copper plates, zinc plates, foamed nickels, foamed aluminums, aluminum honeycombs, and the like; the examples of the glass substrate include glass sheets, glass fibers, hollow glass microspheres, glass beads, glass springs, and the like; the examples of the ceramic substrate include hollow ceramic microspheres, ceramic tiles, ceramic plates, honeycomb ceramics, and the like; the examples of the adsorbent material substrate include silicon oxide, silica gels, activated carbons, zeolites, molecular sieves, and the like. The substrate of the present invention may also be selected from other materials, such as cements, quartz sands, expanded perlites, firebrick particles, wood chips, organic polymers, fabrics, and the like, and is not limited to the substrate exemplified above.

In the method for preparing the nano-TiO₂ photocatalytic coating structure in the present invention, pretreating the substrate to be coated in step 2) preferably includes conducting one or more of the following operations on the substrate: degreasing, derusting, activating, polishing, pickling, and anodizing, for example, conducting cleaning and polishing on the metal substrate, and conducting cleaning and activating on the surface of the glass substrate and ceramic substrate. Pretreatment is used to clean the surface of the substrate, or make the surface of the substrate material became rough with protrusions and/or potholes of nanoscale size. The outer surface with a roughness of nanometer scale can enhance the adhesion of the nano-TiO₂ coating to the substrate.

In the method for preparing the nano-TiO₂ coating structure in the present invention, preferably, the coating in step 3) is selected from one or more methods of the group consisting of spin coating, spray coating, layer coating, roll coating, flow coating and impregnation.

In the method for preparing the nano-TiO₂ coating structure in the present invention, preferably, the nano-TiO₂ coating in step 3) is obtained by sintering, for example, in air at 450-550° C., preferably 450-520° C. In this step, heat treatment is conducted on the titanium-oxide coating coated on the surface of the substrate to decompose the titanium-oxide polymer into the nano-TiO₂, thereby accelerating the diffusion and penetration of the nano-TiO₂ particles at the surface of the substrate, and increasing the bonding strength of the nano-TiO₂ particles to the substrate, wherein the selected substrate should be able to withstand the heat treatment at 450-550° C. for a certain period of time. For the glass substrate which will be softened at 400-550° C., the general heat treatment time is 0.5-2 h.

In the nano-TiO₂ coating structure prepared by the method of the present invention, the thickness of the TiO₂ coating is preferably 10-500 nm, more preferably 50-200 nm, and most preferably 80-150 nm. This is based on the following fact: when the coating is too thin, it is prone to form an incomplete coating on the substrate, which affects the photocatalytic activity of the TiO₂; and when the coating is too thick, the TiO₂ particles are easy to accumulate together, such that the light can only pass through several layers on the surface of the coating, leading to low utilization ratio of the active photocatalytic particles.

In the nano-TiO₂ coating structure prepared by the method of the present invention, preferably, the amount of the TiO₂ coating corresponds to the loading capacity of 1.0-3 g of TiO₂ per cm² of the substrate, more preferably about 1.0-1.5 g of TiO₂ per cm² of the substrate. This is based on the following fact: when the loading capacity is too little, the surface of the substrate is not completely covered by the TiO₂; and when the loading capacity is too much, the TiO₂ particles accumulate together, leading to low utilization ratio of the TiO₂ particles.

In the nano-TiO₂ photocatalytic coating structure prepared by the method of the present invention, the resulting TiO₂ particles preferably have an average particle size of 20-50 nm, particularly 20-30 nm. The particles are composed of basic particles or microcrystalline clusters having a diameter of 2-3 nm. It can be seen from the SEM scan image of the Si slice in one embodiment of the present invention that the size of the TiO₂ particles is about 20 nm.

In the nano-TiO₂ photocatalytic coating structure prepared by the method of the present invention, the resulting TiO₂ is of anatase phase, which can initiate a photocatalytic reaction under excitation of ultraviolet light. The TiO₂ of anatase phase exhibits high catalytic activity, but when the TiO₂ of rutile phase is present, the catalytic activity is reduced. In addition, the super-hydrophilic reaction also can be induced under excitation of ultraviolet light.

In the nano-TiO₂ photocatalytic coating structure prepared by the method of the present invention, the TiO₂ coating is preferably colorless and/or transparent. The colorless and/or transparent coating has a high light transmittance, such that the ultraviolet light and visible light can pass through it effectively.

In the nano-TiO₂ photocatalytic coating structure prepared by the method of the present invention, the shape of the TiO₂ coating varies with the shape of the substrate, for example, a plane or a curved surface, a sphere or any hollow three-dimensional shape, thus this TiO₂ coating has excellent adaptability and compatibility.

The nano-TiO₂ coating structure of the present invention can effectively utilize ultraviolet light to implement the degradation of organic pollutants and inorganic substances as well as the antibacterial, bactericidal, anti-mildew, self-cleaning, anti-fog and anti-fouling effects, etc.

The nano-TiO₂ coating structure of the present invention can solve many problems in practical applications. As mentioned in “BACKGROUND”, the TiO₂ coating obtained by the sol-gel method has a non-porous structure, and the TiO₂ particles are easily agglomerated, which makes the TiO₂ have a small specific surface area and less photocatalytic active centers produced; in addition, since the coating is easily cracked, the loading capacity is usually not very large. Another method in the prior art is to use a TiO₂ suspension to which an organic or inorganic binder is added, however, the photocatalytic efficiency of the nano-TiO₂ photocatalyst is low due to the coating effect of the binder on the photocatalyst. The linear titanium-oxide polymer of the present invention not only serves as a source of TiO₂, but also can function as a surface modifier. It is soluble in a common solvent, has a good film-forming property, and can increase the adhesion of the coating to the substrate, thereby solving the problems of agglomeration of TiO₂ particles and bonding of TiO₂ particles on the substrate. Moreover, the content of Ti in the linear titanium-oxide polymer solution can be adjusted to 0.1-3%, and the loading capacity is controllable and can be relatively large, for example, it can reach above 30% on the glass fiber mat.

In the nano-TiO₂ coating structure of the present invention, different substrates can be used, and various substrates are utilized to develop the application and mass production of the nano-TiO₂ coating structures in different fields. The nano-TiO₂ coating formed on the surface of the substrate can effectively utilize ultraviolet light to degrade organic pollutants and inorganic substances, and has antibacterial, bactericidal, self-cleaning, anti-fog and anti-fouling effects, etc. It has a broad application prospects in the fields of air purification, sewage treatment, and self-cleaning glass, and the like.

The bonding of the TiO₂ coating with metals, glass, ceramics, adsorbent materials and other types of substrate can be utilized to implement different applications. When the TiO₂ forms a coating on the glass, in particular on the basically transparent glass, it can be used to make self-cleaning glass. It also can resist pollution, water vapor, and agglomeration, and can be used in double-glazed glass for buildings, and windshield glass, rear window glass, roof glass, side window glass and rearview mirror glass for automobiles, and the like; glass for trains, planes and ships, and glass for utilities (such as aquarium glass, cabinet glass and greenhouse glass), as well as glass for interior decorative and urban facilities; and glass for television screen, computer screen, telephone screen, and other screens. Such coating structures can also be used in the electrically controlled glass, such as liquid crystal electrochromic glass, electroluminescent glass, and photovoltaic glass.

When the glass fiber cloth is used as the substrate material, the resulting nano-TiO₂-glass fiber cloth coating structure can be used as filter materials, including the material for air purification, sewage purification, removing odor, and also can be used for manufacturing suspended ceiling that is not easy to clean and the like. In addition to degrading organic and inorganic substances during filtration process, the TiO₂ coating can also be used for antibacteria, sterilization and the like.

When the hollow glass beads are used as the substrate material, the resulting nano-TiO₂-hollow glass bead coating structure can be used for filtering water, degrading organic and inorganic substances in water, and also has the function of sterilization.

When the porous ceramic is used as the substrate material, the resulting nano-TiO₂— porous ceramic coating structure can be used for filtration and sterilization of water and air, and also can be used for adding trace elements beneficial to human health.

When the ceramic plate is used as the substrate material, the resulting nano-TiO₂-ceramic plate coating structure can realize the photocatalytic degradation of organic substances, and has a broad application prospects in pollution control, indoor air purification, and self-cleaning coating. The photocatalytic reaction initiated by the TiO₂ itself makes the ceramic have more antibacterial effects. When applied to the hospital, this tile can kill the bacteria attached to the wall; when applied to the bathroom, it can reduce the viscous substances caused by the action of bacteria on the accumulated soap on the floor and wall, and thus has the effects of the anti-slip and anti-fouling; when applied to the toilet, it can obviously reduce the concentration of ammonia which will not make people feel uncomfortable; when applied to the living room as the antibacterial and cleaning ceramic, it not only can kill harmful bacteria, but also can remove harmful gases to some extent so as to purify the indoor air; and when applied to the outer walls of urban buildings as a photocatalytic ceramic outer wall tile, it may reduce the air pollution of the city to some extent.

In the present invention, the linear titanium-oxide polymer is added to a solvent to obtain a uniformly dispersed solution; then the solution is coated on the surface of different substrates, and heat treatment is conducted in air at 450-550° C. to obtain the nano-TiO₂ coating supported on the substrate. In this method, the titanium-oxide polymer is used as a raw material without using any surfactant, and a uniform coating is formed after heat treatment at 450-550° C. The coating is firmly bonded to the substrate, and it has a good effect of photodegrading organic pollutants, and strong antibacterial and bactericidal ability, good hydrophilicity, strong self-cleaning ability and long service life.

The method of the present invention is simple and convenient, and the nano-TiO₂ coating prepared by this method is firm and stable, and can be produced on a large scale. The TiO₂ coating can utilize ultraviolet light to induce photocatalytic reaction, and has a high catalytic activity. The TiO₂ coating has a broad application prospect in the field of photocatalysis such as water treatment, air purification, antibacteria and sterilization, self-cleaning, and the like.

The present invention also provides a glass fiber mat-nano-TiO₂ photocatalytic coating structure comprising a glass fiber mat substrate and a nano-TiO₂ coating supported on the surface of the glass fiber mat substrate, wherein the nano-TiO₂ coating includes nano-TiO₂ particles having an average particle size of 10-50 nm, and the loading capacity of the nano-TiO₂ coating is 5-30 wt % by the weight of the glass fiber mat substrate.

In the glass fiber mat-nano-TiO₂ photocatalytic coating structure of the present invention, each nano-TiO₂ particle in the nano-TiO₂ coating is composed of basic particles or microcrystalline clusters having a diameter of 2-5 nm.

In the glass fiber mat-nano-TiO₂ photocatalyst coating structure of the present invention, the loading capacity of the nano-TiO₂ coating is preferably 10-20 wt %.

In the glass fiber mat-nano-TiO₂ photocatalyst coating structure of the present invention, the thickness of the nano-TiO₂ photocatalytic coating is preferably 50-200 nm, more preferably 80-150 nm.

In the glass fiber mat-nano-TiO₂ photocatalytic coating structure of the present invention, the TiO₂ in the nano-TiO₂ coating is of anatase phase, which can initiate a photocatalytic reaction under excitation of ultraviolet light. The TiO₂ of anatase phase exhibits high catalytic activity, but when the TiO₂ of rutile phase is present, the catalytic activity is reduced. In addition, the super-hydrophilic reaction of the nano-TiO₂ coating can also be induced under excitation of ultraviolet light.

In the glass fiber mat-nano-TiO₂ photocatalytic coating structure of the present invention, the nano-TiO₂ coating is colorless and/or transparent. The colorless and/or transparent coating has a high light transmittance, such that the ultraviolet light and visible light can pass through it effectively.

In the glass fiber mat-nano-TiO₂ photocatalytic coating structure of the present invention, there are no special restrictions on the type and parameter of the glass fiber mat. For example, the glass fiber mat may be a glass fiber chopped strand mat, a glass fiber continuous strand mat, a glass fiber continuous monofilament mat, a glass fiber needled mat, a glass fiber stitched mat, or a glass fiber surface mat; and a glass fiber filament mat is preferred. Also there are no special restrictions on the mass per unit area and the thickness of the glass fiber mat, for example, the mass per unit area may be 100-500 g/m².

In the glass fiber mat-nano-TiO₂ photocatalytic coating structure of the present invention, the nano-TiO₂ photocatalytic coating is formed by sintering the linear titanium-oxide polymer. The linear titanium-oxide polymer is a linear titanium-oxide polymer with repeating Ti—O bonds as the main chain and an organic group attached to a pendant group, and comprises the following structure formula:

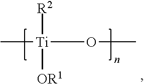

wherein R¹ is independently selected from the group consisting of —C₂H₅, —C₃H₇, —C₄H₉, and —C₅H₁₁; R² represents OR¹ or represents a complexing group selected from the group consisting of CH₃COCHCOCH₃ and CH₃COCHCOOC₂H₅, provided that at least 50% of the R² groups represent the complexing group by the total number of the R² groups; the number average molecular weight (Mn) of the linear titanium-oxide polymer is 2000-3000 as determined by vapor-pressure osmometry; and the solvent-free pure titanium-oxide polymer has a softening point in the range of 90−127° C. as determined by the ring-and-ball method.

The present invention also provides a method for preparing the glass fiber mat-nano-TiO₂ photocatalytic coating structure, comprising the steps of:

1) providing a glass fiber mat;

2) dissolving a linear titanium-oxide polymer in a solvent to prepare a solution;

3) applying the titanium-oxide polymer solution to the glass fiber mat, followed by drying and sintering at 400-550° C., to obtain the glass fiber mat-nano-TiO₂ photocatalytic coating structure;

wherein the linear titanium-oxide polymer in step 2) is a linear titanium-oxide polymer with repeating Ti—O bonds as the main chain and an organic group attached to a pendant group, and comprises the following structure formula:

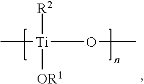

wherein R¹ is independently selected from the group consisting of —C₂H₅, —C₃H₇, —C₄H₉, and —C₅H₁₁; R² represents OR¹ or represents a complexing group selected from the group consisting of CH₃COCHCOCH₃ and CH₃COCHCOOC₂H₅, provided that at least 50% of the R² groups represent the complexing group by the total number of the R² groups; the number average molecular weight (Mn) of the linear titanium-oxide polymer is 2000-3000 asdetermined by vapor-pressure osmometry; and the solvent-free pure titanium-oxide polymer has a softening point in the range of 90-127° C. as determined by the ring-and-ball method.

Preferably, the linear titanium-oxide polymer is soluble in one or more of the group consisting of monohydric alcohols or dihydric alcohols having 2-5 carbon atoms, ethylene glycol monoethers having 3-8 carbon atoms, toluene or xylene.

Preferably, the linear titanium-oxide polymer used in the present invention is prepared by the method comprising the steps of:

1) adding a titanate to a reaction vessel, and adding a chelating agent at 50-90° C., followed by heating and stirring for 0.5-1.5 h;

2) adding a mixed solution of water and alcohol dropwise at 50-90° C., and stirring at 80-110° C. for 1.5-4 h after the addition is completed, cooling the mixture and then removing the solvent under reduced pressure to obtain the titanium-oxide polymer.

In the method for preparing the linear titanium-oxide polymer in the present invention, the titanate preferably has the structure of Ti(OR¹)₄, wherein R¹ is independently selected from the group consisting of —C₂H₅, —C₃H₇, —C₄H₉ and —C₅H₁₁. Preferably the titanate is tetrabutyl titanate.

In the method for preparing the linear titanium-oxide polymer in the present invention, the chelating agent is preferably selected from one or both of acetylacetone and ethyl acetoacetate.

In the method for preparing the linear titanium-oxide polymer in the present invention, the molar ratio of the titanate, the chelating agent and water is preferably 1:(0.5-1.4):(0.8-1.3).

In the method for preparing the linear titanium-oxide polymer in the present invention, the alcohol in the mixed solution of water and alcohol is preferably selected from one or more of monohydric alcohols having 2-5 carbon atoms, and the molar ratio of water to alcohol in the mixed solution of water and alcohol is preferably 1:(3-20).

The linear titanium-oxide polymer prepared in the present invention can be used as a source of nano-TiO₂, and also can be used as a surface modifier. It can be dispersed in an organic solvent at a molecular level, and has a good film-forming property. It can be uniformly supported on the glass fiber mat by simple impregnation, spray coating, layer coating, roll coating, and flow coating, etc., and can increase the adhesion of the coating to the glass fiber substrate. As described in “BACKGROUND”, for the TiO₂ photocatalyst in the prior art, the TiO₂ coating is bonded to the glass fiber mat by using a binder, wherein the TiO₂ particles are easy to be agglomerated or surrounded by the binder, resulting in poor catalytic performance. The glass fiber mat is coated by the linear titanium-oxide polymer prepared in the present invention, then subjected to pyrolysis to obtain the porous nano-TiO₂ coating structure. The resulting coating is uniform without agglomerated TiO₂ particles, and has increased loading capacity of TiO₂ and high photocatalytic efficiency as well as high adhesion of the TiO₂ particles to the glass fiber mat in the case of no binders, thereby overcoming the disadvantages in the prior art. The glass fiber mat-TiO₂ photocatalytic coating structure of the present invention is subjected to ultrasonic treatment at a frequency of 40 KHz for 2 h, and the amount of the shed powder is less than 2 wt %, preferably less than 1.2 wt %.

In the method for preparing the glass fiber mat-nano-TiO₂ photocatalytic coating structure in the present invention, preferably, the glass fiber mat in step 1) is subjected to heat treatment to remove the organic binder on the surface of the glass fiber mat. The removal of the organic binder makes the surface of the glass fiber mat become bulky, and also makes the glass fiber mat have a uniform structure with a large specific surface area. The temperature of the heat treatment is preferably 450-550° C.; and the treatment time is, for example, 0.5-8 h, preferably 1-3 h.

In the method for preparing the glass fiber mat-nano-TiO₂ photocatalytic coating structure in the present invention, preferably, the glass fiber mat in step 1) is activated in hot water to generate more Si—OH active groups on the surface of the glass fiber mat, and the Si—OH active group can form a chemical bond with an active group on the surface of the TiO₂, to implement the function of anchoring and enhance the adhesion of the TiO₂ to the glass fiber, such that the TiO₂ is firmly boned to the glass fiber mat. By using hot water as an activator, no other impurities are introduced, and no acid or alkali is discharged to the environment. The activation temperature is preferably 60-100° C., more preferably 80-100° C.; and the activation time is, for example, 1-15 h, preferably 2-6 h.

In the method for preparing the glass fiber mat-nano-TiO₂ photocatalytic coating structure in the present invention, the linear titanium-oxide polymer of the present invention is dissolved in a solvent in step 2), and the solvent includes one or more of the group consisting of monohydric alcohols or dihydric alcohols having 2-5 carbon atoms, methyl ethers having 3-8 carbon atoms, toluene or xylene. In the obtained linear titanium-oxide polymer solution, the concentration of the solution is preferably 0.1-3 wt %, more preferably 0.3-2 wt % by titanium.

In the method for preparing the glass fiber mat-nano-TiO₂ photocatalytic coating structure in the present invention, the linear titanium-oxide polymer solution is applied to the treated glass fiber mat in step 3), wherein the application is selected from one or more methods of the group consisting of spin coating, spray coating, layer coating, roll coating, flow coating, and impregnation. Then sintering is conducted for example, in air, at 400-550° C., preferably 450-520° C. In this step, heat treatment is performed on the linear titanium-oxide polymer coating coated on the surface of the glass fiber mat, to decompose the linear titanium-oxide polymer into the nano-TiO₂, thereby accelerating the diffusion and penetration of the nano-TiO₂ particles at the surface of the glass fiber mat, and increasing the bonding strength of the nano-TiO₂ particles to the glass fiber mat. The sintering time is usually 0.5-6 h, preferably 0.5-3 h.

In the glass fiber mat-nano-TiO₂ photocatalytic coating structure prepared by the method of the present invention, the thickness of the TiO₂ coating is preferably 10-500 nm, more preferably 50-200 nm, and most preferably 80-150 nm.

In the glass fiber mat-nano-TiO₂ photocatalytic coating structure prepared by the method of the present invention, the resulting TiO₂ particles preferably have an average particle size of 20-50 nm, particularly 20-30 nm, and the particles are composed of basic particles or microcrystalline clusters having a diameter of 2-3 nm.

In the glass fiber mat-nano-TiO₂ photocatalytic coating structure prepared by the method of the present invention, the resulting TiO₂ is of anatase phase, which can initiate a photocatalytic reaction under excitation of ultraviolet light. The TiO₂ of anatase phase exhibits high catalytic activity, but when the TiO₂ of rutile phase is present, the catalytic activity is reduced. In addition, the super-hydrophilic reaction can also be induced under excitation of ultraviolet light.

In the glass fiber mat-nano-TiO₂ photocatalytic coating structure prepared by the method of the present invention, the TiO₂ coating is preferably colorless and/or transparent. The colorless and/or transparent coating has a high light transmittance, such that the ultraviolet light and visible light can pass through it effectively.

The glass fiber mat-nano-TiO₂ photocatalytic coating structure of the present invention can effectively utilize ultraviolet light to implement the degradation of organic pollutants and inorganic substances as well as antibacterial, bactericidal and anti-mildew effects and the like.

The linear titanium-oxide polymer of the present invention not only serves as a source of TiO₂, but also can function as a surface modifier. It is soluble in a common solvent, has a good film-forming property, and can increase the adhesion of the coating to the substrate, thereby solving the problems of agglomeration of TiO₂ particles and bonding of TiO₂ particles on the substrate. Moreover, the content of Ti in the linear titanium-oxide polymer solution can be adjusted to 0.1-3 wt %, and the loading capacity is controllable and can be relatively large, for example, it can reach above 30 wt % on the glass fiber mat.

According to the present invention, a nano-TiO₂ photocatalyst coating is formed on a glass fiber mat, which promotes the activity of the photocatalytic degradation on the organic substance due to the unique structure of the glass fiber mat. The glass fiber mat has a large surface area and thus can provide more attachment points for TiO₂ to improve the degradation efficiency of the pollutants. The experiment has proved that the glass fiber mat-nano-TiO₂ photocatalytic coating structure of the present invention has a great degradation capacity to methyl orange under ultraviolet light; moreover, such coating structure has antibacterial and bactericidal effects and can achieve durable use.

According to the present invention, a TiO₂ coating is prepared by using a linear titanium-oxide polymer solution with a glass fiber mat as the substrate. This preparation procedure facilitates the formation of thenano-TiO₂ structure, which increases the number of the catalytic active sites on the surface of the catalyst, and is thus conducive to the adsorption of pollutants and the process of the reaction.

In yet another aspect, the present invention provides the use of the glass fiber mat-nano-TiO₂ photocatalytic coating structure in the fields of air purification, water treatment, deodorization, antibacterial, bactericidal and anti-mildew applications, for example, used for deodorizing filters, antibacterial filters, air purification, transport vehicle purification, smoking room filters, household appliance purifiers, and the like.

### BRIEF DESCRIPTION OF THE DRAWINGS

FIG. 1-1 shows the infrared spectrum of the linear titanium-oxide polymer according to one embodiment of the present invention;

FIG. 1-2 shows the H-NMR spectrum of the linear titanium-oxide polymer according to one embodiment of the present invention;

FIG. 1-3 shows the XRD curve of the linear titanium-oxide polymer which is subjected to heat treatment in air at 450° C. for 3 h according to one embodiment of the present invention;

FIG. 2-1 shows the infrared spectrum of the linear titanium-oxide polymer according to one embodiment of the present invention;

FIG. 2-2 shows the H-NMR spectrum of the linear titanium-oxide polymer according to one embodiment of the present invention;

FIG. 2-3 shows the XRD curve of the linear titanium-oxide polymer which is subjected to heat treatment in air at 500° C. for 2 h according to one embodiment of the present invention;

FIG. 3 shows the XRD curve of the linear titanium-oxide polymer which is subjected to heat treatment in air at 400° C. for 2 h according to one embodiment of the present invention;

FIG. 4 shows the XRD curve of the linear titanium-oxide polymer which is subjected to heat treatment in air at 550° C. for 1.5 h according to one embodiment of the present invention;

FIG. 5-1 shows the scanning electron micrograph of the coating structure taken from an angle according to one embodiment of the present invention;

FIG. 5-2 shows the scanning electron micrograph of the coating structure taken from another angle according to one embodiment of the present invention;

FIG. 6 shows the scanning electron micrograph of the coating structure according to another embodiment of the present invention;

FIG. 7 shows the scanning electron micrograph of the coating structure according to still another embodiment of the present invention;

FIG. 8 shows the scanning electron micrograph of the coating structure according to yet another embodiment of the present invention;

FIG. 9-1, FIG. 9.2 and FIG. 9-3 show the scanning electron micrographs of the glass fiber mat-nano-TiO₂ coating structure under different magnifications according to one embodiment of the present invention; wherein the loading capacity of the TiO₂ is 10.5 wt % by the weight of the glass fiber mat.

### DETAILED DESCRIPTION OF THE EMBODIMENTS

The technical solutions of the present invention are further described below with reference to the specific examples, but the present invention is not limited thereto.

Unless defined otherwise, all technical and scientific terms used herein have the same meaning as commonly understood by one of ordinary skill in the art to which the present invention belongs. In the event of any contradiction, the definitions in this specification shall prevail.

Unless otherwise stated, all percentages, parts, ratios and the like are expressed by weight.

### Example 1

The method for preparing a titanium-oxide polymer provided in this example was conducted according to the following steps:

1) 1 mol tetraisobutyl titanate was added to a reaction vessel, followed by 0.8 mol acetylacetone; then the mixture was heated and stirred at 50° C. for 1 h;

2) the temperature was adjusted to 80° C., and a mixed solution of 0.8 mol water and 2.5 mol isobutanol was added dropwise; the mixture was heated and stirred at 90° C. for 2 h after the addition was completed; after the mixture was cooled, the solvent was removed under reduced pressure to obtain a yellow titanium-oxide polymer.

The softening point was 92° C. as measured by the ring-and-ball method; and the number average molecular weight (Mn) was 2750 as measured by the vapor-pressure osmometry.

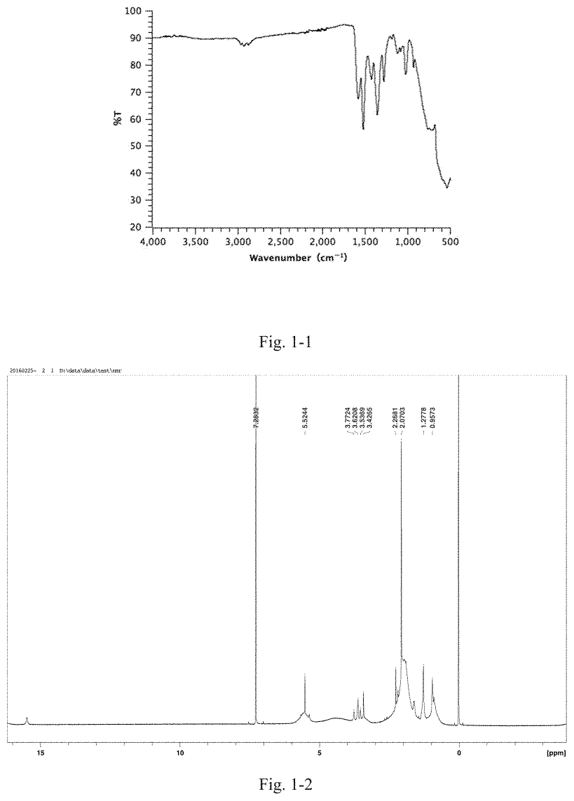

The obtained yellow titanium-oxide polymer (1-2 mg) and pure KBr (200 mg) were ground finely and uniformly, placed in a mold, and pressed into a transparent sheet on a tableting machine for IR spectrum characterization, as shown in FIG. 1-1. In FIG. 1-1, the peaks at 2959 cm⁻¹, 2922 cm⁻¹ and 2872 cm⁻¹ are C—H stretching vibration peaks; and the peaks at 1592 cm⁻¹ and 1531 cm⁻¹ belong to the absorption peaks of C═O (keto form) and C═C (enol form) at 425 cm⁻¹ and 543 cm⁻¹ in the acetylacetone ligand, proving the presence of Ti—O bonds in the structure of the polymer.

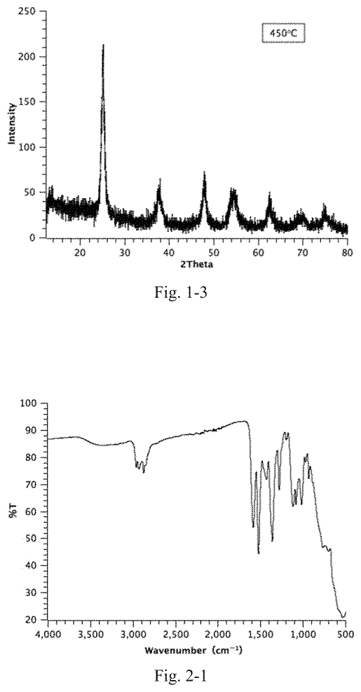

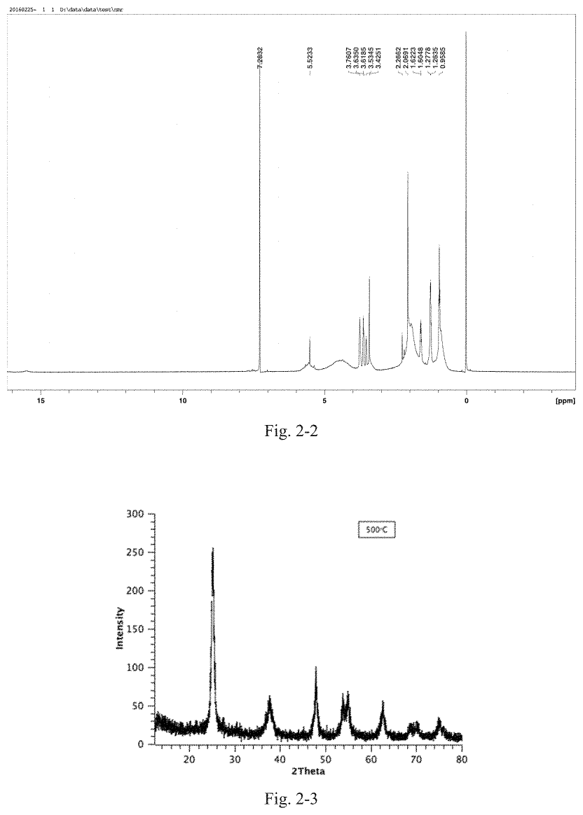

The obtained yellow titanium-oxide polymer was dissolved in deuterated chloroform for NMR characterization, and the results are shown in FIG. 1-2.

The obtained yellow titanium-oxide polymer was treated in air at 450° C. for 2 h to obtain a TiO₂ photocatalyst, part of which was used for XRD test and characterization, as shown in FIG. 1-3. It can be seen from the figure that the TiO₂ obtained after cracking of the titanium-oxide polymer is the anatase TiO₂.

50 mg of the TiO₂ photocatalyst obtained by treatment in air at 450° C. for 2 h was weighed and added to 50 ml of methyl orange solution (at a concentration of 15 mg/L), and the degradation rate was 82.8% after illumination by a 500 W mercury lamp for 2.5 h. It can be seen that the TiO₂ has a significant photocatalytic performance.

### Example 2

The method for preparing a titanium-oxide polymer provided in this example was conducted according to the following steps:

1) 1 mol tetrabutyl titanate was added to a reaction vessel, followed by 0.5 mol acetylacetone, then the mixture was heated and stirred at 90° C. for 1.5 h;

2) the temperature was adjusted to 70° C., and a mixed solution of 1.2 mol water and 6 mol n-butanol was added dropwise; the mixture was stirred at 100° C. for 2.5 h after the addition was completed; after the mixture was cooled, the solvent was removed under reduced pressure to obtain the titanium-oxide polymer.

The softening point was 98° C. as measured by the ring-and-ball method; and the number average molecular weight (Mn) was 2930 as measured by the vapor-pressure osmometry.

The obtained titanium-oxide polymer (1-2 mg) and pure KBr (200 mg) were ground finely and uniformly, placed in a mold, and pressed into a transparent sheet on a tableting machine for IR spectrum characterization, as shown in FIG. 2-1.

The obtained titanium-oxide polymer was dissolved in deuterated chloroform for NMR characterization, and the results are shown in FIG. 2-2.

The obtained titanium-oxide polymer was treated in air at 500° C. for 1 h to obtain a TiO₂ catalyst, part of which was used for XRD test and characterization, as shown in FIG. 2-3.

50 mg of the catalyst obtained by treatment in air at 500° C. for 1 h was weighed and added to 50 ml of methyl orange solution (at a concentration of 15 mg/L), and the degradation rate was 79.3% after illumination by a 500 W mercury lamp for 2.5 h. It can be seen that the TiO₂ has a significantly photocatalytic performance.

### Example 3

The method for preparing a titanium-oxide polymer provided in this example was conducted according to the following steps:

1) 1 mol tetrapropyl titanate was added to a reaction vessel, followed by 1.4 mol ethyl acetoacetate; then the mixture was heated and stirred at 60° C. for 1 h;

2) the temperature was adjusted to 80° C., and a mixed solution of 0.8 mol water and 2.5 mol n-propanol was added dropwise; the mixture was continued to be heated and stirred at 80° C. for 3 h after the addition was completed; after the mixture was cooled, the solvent was removed under reduced pressure to obtain the titanium-oxide polymer.

The softening point was 107° C. as measured by the ring-and-ball method; and the number average molecular weight (Mn) was 2200 as measured by the vapor-pressure osmometry.

The obtained titanium-oxide polymer was treated in air at 400° C. for 1 h to obtain a TiO₂ catalyst, and part of the powder was used for XRD test, as shown in FIG. 3.

50 mg of the TiO₂ catalyst obtained by treatment in air at 400° C. for 1 h was weighed and added to 50 ml of methyl orange solution (at a concentration of 15 mg/L), and the degradation rate was 60.2% after illumination by a 500 W mercury lamp for 2.5 h. It can be seen that the TiO₂ has a significantly photocatalytic performance.

### Example 4

The method for preparing a titanium-oxide polymer provided in this example was conducted according to the following steps:

1) 1 mol tetraethyl titanate was added to a reaction vessel, followed by 0.8 mol acetylacetone, then the mixture was heated and stirred at 50° C. for 1 h;

2) the temperature was adjusted to 60° C., and a mixed solution of 0.8 mol water and 2.5 mol ethanol was added dropwise; the mixture was continued to be heated and stirred at 60° C. for 4 h after the addition was completed; after the mixture was cooled, the solvent was removed under reduced pressure to obtain the titanium-oxide polymer.

The softening point was 115° C. as measured by the ring-and-ball method; and the number average molecular weight (Mn) was 2050 as measured by the vapor-pressure osmometry.

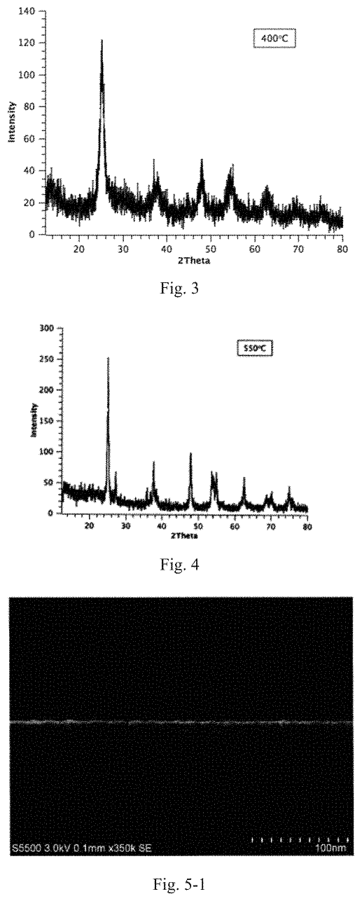

The obtained titanium-oxide polymer was subjected to heat treatment in air at 550° C. for 2 h to obtain a TiO₂ photocatalyst, and part of the powder was used for XRD test, as shown in FIG. 4. It can be seen from the figure that the TiO₂ of rutile phase appeared.

50 mg of the TiO₂ catalyst obtained by treatment in air at 550° C. for 1 h was weighed and added to 50 ml of methyl orange solution (at a concentration of 15 mg/L), and the degradation rate was 59.2% after illumination by a 500 W mercury lamp for 2.5 h; this is due to the appearance of the TiO₂ of rutile phase, which leads to a reduced degradation rate.

### Example 5: Preparation of a Linear Titanium-Oxide Polymer

1) 1 mol tetraisobutyl titanate was added to a reaction vessel, and the temperature was adjusted to 50° C.; then 0.8 mol acetylacetone was added, and the mixture was heated and stirred at 50° C. for 1 h;

2) the temperature was adjusted to 80° C., and a mixed solution of 0.8 mol water and 2.5 mol isobutanol was added dropwise; the mixture was continued to be heated and stirred at 80° C. for 2 h after the addition was completed; after the mixture was cooled, the solvent was removed under reduced pressure to obtain a yellow titanium-oxide polymer.

The softening point was 92° C. as measured by the ring-and-ball method; and the number average molecular weight (Mn) was 2750 as measured by the vapor-pressure osmometry.

The obtained yellow titanium-oxide polymer (1-2 mg) and pure KBr (200 mg) were ground finely and uniformly, placed in a mold, and pressed into a transparent sheet on a tableting machine for IR spectrum characterization. The peaks at 2959 cm⁻¹, 2922 cm⁻¹ and 2872 cm⁻¹ are C—H stretching vibration peaks; and the peaks at 1592 cm⁻¹ and 1531 cm⁻¹ belong to the absorption peaks of C═O (keto form) and C═C (enol form) at 425 cm⁻¹ and 543 cm−1 in the acetylacetone ligand, proving the presence of Ti—O bonds in the structure of the polymer.

### Example 6: Preparation of a Linear Titanium-Oxide Polymer

1) 1 mol tetrabutyl titanate was added to a reaction vessel, followed by 0.5 mol acetylacetone, then the mixture was heated and stirred at 90° C. for 1.5 h;

2) the temperature was adjusted to 70° C., and a mixed solution of 1.2 mol water and 6 mol n-butanol was added dropwise; the mixture was stirred at 100° C. for 2.5 h after the addition was completed; after the mixture was cooled, the solvent was removed under reduced pressure to obtain the titanium-oxide polymer.

The softening point was 98° C. as measured by the ring-and-ball method; and the number average molecular weight (Mn) was 2930 as measured by the vapor-pressure osmometry.

### Example 7: Preparation of a Nano-TiO₂ Coating Structure Supported on a Silicon Slice

1) The linear titanium-oxide polymer prepared in Example 6 was dissolved in ethanol to prepare a solution having a concentration of 0.4 wt % by Ti;

2) A silicon slice was ultrasonically cleaned in acetone, absolute ethanol and deionized water for 15 min respectively, and dried in air;

3) The silicon slice (2 cm×2 cm) was coated with the titanium-oxide polymer solution by spin coating, dried, and subjected to heat treatment in air at 500° C. for 30 min to obtain the nano-TiO₂ coating structure supported on the silicon slice uniformly.

The TiO₂ in the obtained coating structure was analyzed by XRD, confirming that the TiO₂ obtained after heat treatment of the linear titanium-oxide polymer was the anatase TiO₂.

The electron micrographs of the coating structure taken from different angles are shown in FIG. 5-1 and FIG. 5-2. It can be seen from the figures that the obtained coating has a flat surface, uniform thickness and porous structure, and the average particle size of the TiO₂ particles is about 20 nm. The experimental results show that the titanium-oxide polymer has a good film-forming property, and the TiO₂ coating obtained after heat treatment is well supported on the Si slice.

### Example 8: Preparation of a Nano-TiO₂ Coating Structure Supported on a Silicon Slice

The preparation procedure was carried out according to the same steps as in Example 7, except that the prepared linear titanium-oxide polymer solution has a concentration of 0.8 wt % by Ti. The silicon slice was subjected to spin coating, drying, and heat treatment under the same conditions, to obtain the nano-TiO₂ coating structure supported on the silicon slice uniformly.

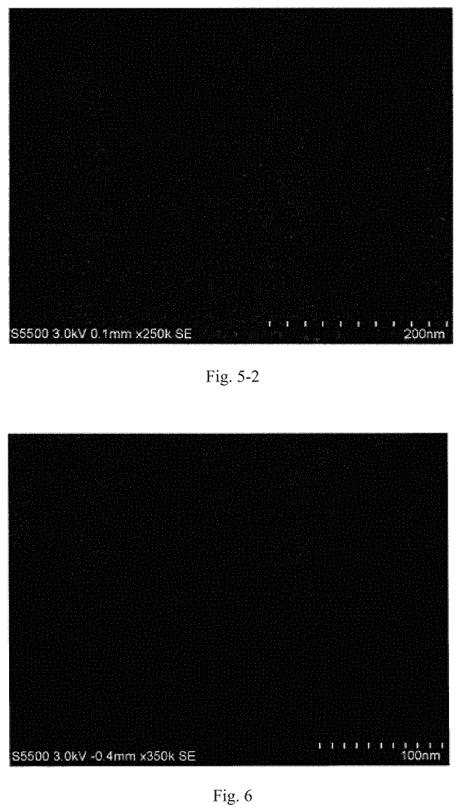

The electron micrograph of the coating structure is shown in FIG. 6, and the resulting coating has a thickness of 50 nm.

### Example 9: Preparation of a Nano-TiO₂ Coating Structure Supported on a Quartz Glass Sheet

1) The titanium-oxide polymer prepared in Example 5 was dissolved in ethanol to prepare a solution having a concentration of 0.4 wt % by Ti;

2) A quartz glass sheet was ultrasonically cleaned in acetone, absolute ethanol and deionized water for 15 min respectively, and dried in air;

3) The quartz glass sheet (2 cm×2 cm) was coated with the titanium-oxide polymer solution by spin coating, and dried (the thickness of the wet film was 80 nm as measured by a step profiler); then the quartz glass sheet coated with wet film was subjected to heat treatment in air at 500° C. for 30 min to obtain the nano-TiO₂ coating structure supported on the quartz glass sheet uniformly, with a coating thickness of 30 nm.

The obtained nano-TiO₂-quartz glass coating structure was subjected to transmission test under visible light, and the transmittance was determined to be 89.2%.

In the room temperature, the contact angles of five different positions of the quartz glass sheet were measured by a contact angle measuring device before the quartz glass sheet was coated with the titanium-oxide polymer solution, and the contact angle was measured to be 72°. The contact angles of five different positions at the surface of the coating structure were measured after the quartz glass sheet was loaded with TiO₂ coating, and the contact angle was measured to be 5°. This indicated that the TiO₂ coating prepared by the method of the present invention has super-hydrophilicity, which makes the TiO₂ coating structure have performances of self-cleaning and decontamination, easy to clean, water-proof and fog-proof, etc.

### Example 10: Preparation of a Nano-TiO₂ Coating Structure Supported on a Quartz Glass Sheet

1) The titanium-oxide polymer prepared in Example 5 was dissolved in ethanol to prepare a solution having a concentration of 0.8 wt % by Ti;

2) A quartz glass sheet was ultrasonically cleaned in acetone, absolute ethanol and deionized water for 15 min respectively, and dried in air;

3) The quartz glass sheet (2 cm×4 cm) was coated with the titanium-oxide polymer solution by impregnation, and dried; then the quartz glass sheet coated with wet film was subjected to heat treatment in air at 500° C. for 60 min to obtain the nano-TiO₂ coating structure supported on the quartz glass sheet uniformly.

5 pieces of the obtained nano-TiO₂-quartz glass coating structure were taken, and the surface of the coating structure was scratched in grids by the grid-scratching method. Then the transparent tape was repeatedly pasted and peeled off to observe the integrity of the TiO₂ coating, and the adhesive force of the TiO₂ coating to the surface of the coating structure was evaluated by the number of times of pasting. Thereafter, the contact angle of the water droplet on the surface of the coating structure was observed; or the integrity of the water film on the surface of the coating was observed when the coating structure was inserted into water and then pulled out.

| Coating | | Adhesive force | |
|---|---|---|---|
| structure of a | | (the number of | Hydrophilicity |
| glass sheet | Appearance | times of pasting) | (contact angle) |
| 1 | qualified | 100 | 0 |
| 2 | qualified | 100 | 0 |
| 3 | qualified | 100 | 0 |
| 4 | qualified | 100 | 0 |
| 5 | qualified | 100 | 0 |

The contrast test was carried out between the nano-TiO₂-quartz glass coating structure obtained in this example and the uncoated quartz glass: tap water was sprayed on the surface of the nano-TiO₂-quartz glass coating structure obtained in this example, then a continuous water film was formed on the surface of the coating when the spraying was completed, and there were no water marks on the surface of the coating when the entire water film flowed down the substrate; however, when the uncoated quartz glass was sprayed with water, the water droplets were formed on the surface of the quartz glass, and water marks were left on the surface of the substrate after the water flowed away. This indicates that the coating of the present invention has a good hydrophilicity.

Due to the super-hydrophilicity, the nano-TiO₂-quartz glass coating structure of this example can act as an automobile rearview mirror, moisture-resistant glass and anti-fouling glass which do not need to be wiped, particularly suitable for outdoor architectural glass. In addition, the photocatalytic property of the nano-TiO₂-quartz glass coating structure can also be used to develop various products such as anti-fouling liquid crystal displays.

At present, the self-cleaning glass is used in the construction industry, but in fact it can also be applied in the field of super glass used in solar cells.

The above nano-TiO₂-quartz glass coating structure (2 cm×4 cm) was added to 50 ml of methyl orange solution (at a concentration of 15 mg/L), and the degradation rate of the methyl orange solution was tested to be 50% after illumination by a 500 W mercury lamp for 5 h; and the degradation rate of the methyl orange solution reached 80% after illumination for 8 h.

As can be seen from the above test, the self-cleaning function of the super-hydrophilic self-cleaning glass was as follows: by virtue of the affinity of the coating surface for water, the contact angle of the water droplets on the surface of the coating tended to zero; when the water came into contact with the coating, it spread rapidly on the surface of the coating, and then a uniform water film was formed, indicating that the coating has a super-hydrophilic property, and most of the organic or inorganic stains can be removed by the gravity drop of the uniform water film.

The above technical solution adopted by the present invention achieves the following beneficial effects: the present invention mainly solves the problems of uneven coating and poor coating appearance quality caused during the large-scale production of the self-cleaning glass and the like; moreover, the coating can be more firmly bonded to the surface of the glass substrate, ensuring the service life of the coating structure. The self-cleaning glass coating prepared in the present invention has a clear appearance and an effect of increasing transmittance.

### Example 11: Preparation of a Nano-TiO₂ Coating Structure Supported on an Aluminium Sheet

1) The linear titanium-oxide polymer prepared in Example 6 was dissolved in ethanol to prepare a solution having a concentration of 0.4 wt % by Ti;

2) An aluminium sheet (9 cm×2 cm×0.1 cm) was ultrasonically cleaned in acetone and absolute ethanol for 15 min respectively to remove the oil stain on the surface, then the aluminium sheet was oxidized in phosphoric acid; after the oxidation was completed, the residues on the surface were washed away with deionized water, and then the aluminium sheet was dried in air;

3) The aluminium sheet was coated with the titanium-oxide polymer solution by impregnation, dried, and subjected to heat treatment in air at 500° C. for 2 h to obtain the nano-TiO₂ coating structure supported on the aluminium sheet uniformly.

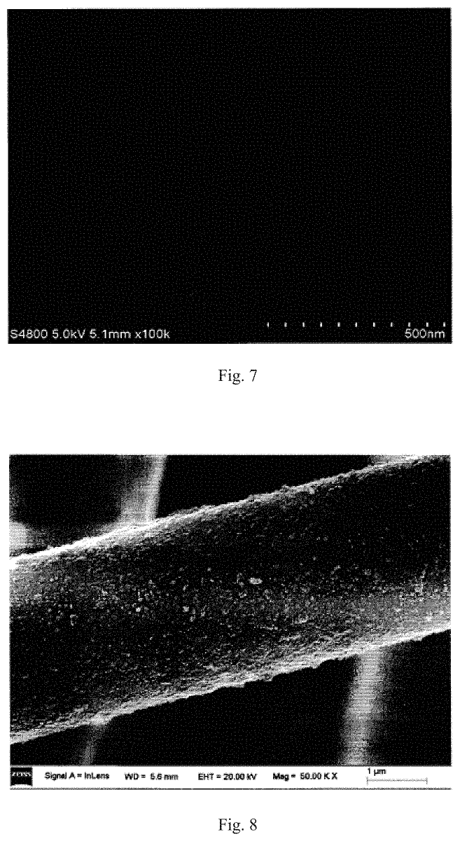

The SEM micrograph of the coating structure is shown in FIG. 7. It can be seen from FIG. 7 that the obtained coating has a flat surface, with a uniform thickness and good transparency. The particle size of the TiO₂ particles is 20 nm, and the thickness of the coating is 30 nm.

The above nano-TiO₂-aluminium sheet coating structure (1.4407 g) was added to 50 ml of methyl orange solution (at a concentration of 15 mg/L), and the methyl orange solution was illuminated by a 500 W mercury lamp for 5 h, then the absorption spectrum of the methyl orange solution was tested, and degradation rate was tested to be 67.5%; and the degradation rate was tested to be 79.3% after degradation for 8 h.

0.0019 g of TiO₂ was coated on the aluminum sheet as described above, and 5.8 g of TiO₂ was coated on average per cm² of aluminum sheet irrespective of the roughness of the surface.

5 pieces of the obtained nano-TiO₂— aluminum sheet coating structure were taken, and the surface of the coating structure was scratched in grids by the grid-scratching method. Then the transparent tape was repeatedly pasted and peeled off to observe the integrity of the TiO₂ coating, and the adhesive force of the TiO₂ coating to the surface of the coating structure was evaluated by the number of times of pasting. Thereafter, the contact angle of the water droplet on the surface of the coating structure was observed; or the integrity of the water film on the surface of the coating was observed when the coating structure was inserted into water and then pulled out.

| Coating | | Adhesive force | |
|---|---|---|---|
| structure of an | | (the number of | Hydrophilicity |
| aluminum sheet | Appearance | times of pasting) | (contact angle) |
| 1 | qualified | 150 | 0 |
| 2 | qualified | 150 | 0 |
| 3 | qualified | 150 | 0 |
| 4 | qualified | 150 | 0 |
| 5 | qualified | 150 | 0 |

The hydrophilic experiment of the TiO₂ coating on the aluminum sheet was carried out: a continuous water film can be formed on the surface of the coating, and when the entire water film flowed down the surface of the coating, there were no water marks on the surface of the coating; however, when the aluminum sheet without TiO₂ coating was sprayed with water, the water droplets were formed on the surface of the aluminum sheet, and water marks were left on the surface of the substrate after the water flowed away. This indicates that the coating of the present invention has a good hydrophilicity.

It can be seen from the above test that the nano-TiO₂ coating structure of the present invention not only can degrade organic substances, but also has hydrophilicity; it has a certain self-cleaning function, and thus can be applied to indoor household appliances; moreover, it has the functions of purifying air, deodorizing, sterilizing and self-cleaning.

### Example 12: Preparation of a Nano-TiO₂Coating Structure Supported on a Titanium Sheet

1) The linear titanium-oxide polymer prepared in Example 6 was dissolved in ethanol to obtain a solution having a concentration of 0.4 wt % by Ti;

2) A titanium sheet (9 cm×2 cm×0.1 cm) was ultrasonically cleaned in acetone, absolute ethanol and pure water for 15 min respectively, and then blow-dried;

3) The titanium sheet was coated with the titanium-oxide polymer solution by impregnation, dried, and subjected to heat treatment in air at 500° C. for 30 min to obtain the nano-TiO₂ coating structure supported on the titanium sheet uniformly.

The above coating structure (1.3459 g) was added to 50 ml of methyl orange solution (at a concentration of 15 mg/L), and the methyl orange solution was illuminated by a 500 W mercury lamp for 5 h, and the degradation rate of the methyl orange solution was tested to be 82%; and methyl orange was completely degraded after being illuminated for 8 h.

0.0020 g of TiO₂ was coated on the titanium sheet as described above, and 6.2 μg of TiO₂ was coated on average per cm² of titanium sheet irrespective of the roughness of the surface.

5 pieces of the obtained nano-TiO₂— titanium sheet coating structure were taken, and the surface of the coating structure was scratched in grids by the grid-scratching method. Then the transparent tape was repeatedly pasted and peeled off to observe the integrity of the TiO₂ coating, and the adhesive force of the TiO₂ coating to the surface of the coating structure was evaluated by the number of times of pasting. Thereafter, the contact angle of the water droplet on the surface of the coating structure was observed; or the integrity of the water film on the surface of the coating was observed when the coating structure was inserted into water and then pulled out.

| Coating | | Adhesive force | |
|---|---|---|---|
| structure of | | (the number of | Hydrophilicity |
| atitanium sheet | Appearance | times of pasting) | (contact angle) |
| 1 | qualified | 100 | 0 |
| 2 | qualified | 100 | 0 |
| 3 | qualified | 100 | 0 |
| 4 | qualified | 100 | 0 |
| 5 | qualified | 100 | 0 |

The hydrophilic experiment of the TiO₂ coating on the titanium sheet was carried out: a continuous water film can be formed on the surface of the coating, and when the entire water film flowed down the surface of the coating, there were no water marks on the surface of the coating; however, when the titanium sheet without coating was sprayed with water, water droplets were formed on the surface of the aluminum sheet, and water marks were left on the surface of the substrate after the water flowed away. This indicates that the coating of the present invention has a good hydrophilicity.

It can be seen from the above test that the nano-TiO₂ coating structure supported on the titanium sheet not only can degrade organic substances, but also has hydrophilicity; it has a certain self-cleaning function, and thus can be applied to indoor household appliances; moreover, it has the functions of purifying air, deodorizing, sterilizing and self-cleaning.

### Example 13: Preparation of a Nano-TiO₂Coating Structure Supported on a Foamed Nickel

1) The linear titanium-oxide polymer prepared in Example 1 was dissolved in ethanol to obtain a solution having a concentration of 0.4 wt % by Ti;

2) A foamed nickel (9 cm long, and 2 cm wide) was ultrasonically cleaned in acetone, absolute ethanol and pure water for 15 min respectively, and then blow-dried;

3) The foamed nickel was coated with the linear titanium-oxide polymer solution by impregnation, dried, and subjected to heat treatment in air at 500° C. for 30 min to obtain the nano-TiO₂ coating structure supported on the foamed nickel uniformly.

The above coating structure (0.5525 g) was added to 50 ml of methyl orange solution (at a concentration of 15 mg/L), and the methyl orange solution was illuminated by a 500 W mercury lamp for 8 h, and the degradation rate of the methyl orange solution was tested to be 57.2%.

The coating structure described above was subjected to ultrasonic treatment for 2 h by an ultrasonic instrument with a working frequency of 20 KHz, and almost no powder shed off.

The nano-TiO₂ coating structure supported on the foamed nickel prepared in this example has a good stability. When it is used repeatedly, its photocatalytic activity can be completely recovered and regenerated by simple methods such as heating and washing with water, and it can continue to maintain its good stability.

By utilizing the TiO₂ photocatalytic coating, the coating structure can be used for degradation of organic substances and indoor formaldehyde, and also can be used for sterilization, deodorization and filtration, etc.

### Example 14: Preparation of a Nano-TiO₂Coating Structure Supported on a Glass Fiber Cloth

1) The linear titanium-oxide polymer prepared in Example 6 was dissolved in ethanol to obtain a solution having a concentration of 0.4 wt % by Ti;

2) A glass fiber cloth was cut into a square with a side length of 2 cm, and activated in hot water;

3) The glass fiber cloth was coated with the titanium-oxide polymer solution by impregnation, dried, and subjected to heat treatment in air at 480° C. for 30 min to obtain the nano-TiO₂ coating structure supported on the glass fiber cloth uniformly.

The electron micrograph of the coating structure is shown in FIG. 8. It can be seen from FIG. 8 that the obtained coating has a flat surface with a uniform thickness.

The above coating structure (0.2859 g) was added to 50 ml of methyl orange solution (at a concentration of 15 mg/L), and the methyl orange solution was illuminated by a 500 W mercury lamp for 8 h, and the degradation rate of the methyl orange solution was tested to be 88.8%.

The glass fiber cloth coated with TiO₂ coating was subjected to ultrasonic treatment for 2 h by an ultrasonic instrument with a working frequency of 20 KHz, and the shed rate of the powder was 0.1 wt %.

The TiO₂ coating structure supported on the glass fiber cloth prepared in this example can be used as filter materials to degrade the pollutants in water, and such glass fiber cloth can also be used for sterilization, deodorization and the like.

### Example 15: Preparation of a Nano-TiO₂Coating Structure Supported on a Porous Ceramic

1) The linear titanium-oxide polymer prepared in Example 5 was dissolved in ethanol to obtain a solution having a concentration of 0.9 wt % by Ti;

2) A porous ceramic was washed;

3) The porous ceramic was coated with the linear titanium-oxide polymer solution by impregnation, dried, and subjected to heat treatment in air at 520° C. for 1.5 h to obtain the nano-TiO₂ coating structure supported on the porous ceramic.

The above coating structure (6.1924 g) was added to 50 ml of methyl orange solution (at a concentration of 15 mg/L), and the degradation rate of the methyl orange solution was 58.0% after illumination by a 500 W mercury lamp for 5 h; and the degradation rate of the methyl orange solution was 78.0% after illumination for 8 h.

The porous ceramic coated with TiO₂ coating was subjected to ultrasonic treatment for 120 min by a ultrasonic instrument with a working frequency of 20 KHz, and almost no powder shed off.

By utilizing the TiO₂ photocatalytic coating, the nano-TiO₂ coating structure supported on the porous ceramic prepared in this example can be used for degradation of indoor formaldehyde, as well as sterilization and deodorization, etc.

### Example 16: Preparation of a Nano-TiO₂Coating Structure Supported on a Molecular Sieve

1) The linear titanium-oxide polymer prepared in Example 5 was dissolved in ethanol to obtain a solution having a concentration of 0.2 wt % by Ti;

2) A molecular sieve was washed;

3) The molecular sieve was coated with the linear titanium-oxide polymer solution by impregnation, dried, and subjected to heat treatment in air at 500° C. for 1.0 h to obtain thenano-TiO₂ coating structure supported on the molecular sieve uniformly.

The above coating structure (0.2500 g) was added to 50 ml of methyl orange solution (at a concentration of 15 mg/L), and the degradation rate of the methyl orange solution was 76.2% after illumination by a 500 W mercury lamp for 4 h.

By utilizing the TiO₂ photocatalytic coating, the nano-TiO₂ coating structure supported on the molecular sieve prepared in this example can be used for degradation of indoor organic and inorganic substances in water, and also can be used for sterilization and deodorization, etc.

### Example 17: Preparation of a Linear Titanium-Oxide Polymer

1) 1 mol tetraisobutyl titanate was added to a reaction vessel, and the temperature was adjusted to 50° C.; then 0.8 mol acetylacetone was added, and the mixture was heated and stirred at 50° C. for 1 h;

2) The temperature was adjusted to 80° C., and a mixed solution of 0.8 mol water and 2.5 mol isobutanol was added dropwise; the mixture was continued to be heated and stirred at 80° C. for 2 h after the addition was completed; after the mixture was cooled, the solvent was removed under reduced pressure to obtain a yellow titanium-oxide polymer.

The softening point was 92° C. as measured by the ring-and-ball method; and the number average molecular weight (Mn) was 2750 as measured by the vapor-pressure osmometry.

The obtained yellow titanium-oxide polymer (1-2 mg) and pure KBr (200 mg) were ground finely and uniformly, placed in a mold, and pressed into a transparent sheet on a tableting machine for IR spectrum characterization. The peaks at 2959 cm⁻¹, 2922 cm⁻¹ and 2872 cm⁻¹ are C—H stretching vibration peaks; and the peaks at 1592 cm⁻¹ and 1531 cm-belong to the absorption peaks of C═O (keto form) and C═C (enol form) at 425 cm⁻¹ and 543 cm⁻¹ in the acetylacetone ligand, proving the presence of Ti—O bonds in the structure of the polymer.

### Example 18: Preparation of a Linear Titanium-Oxide Polymer

1) 1 mol tetrabutyl titanate was added to a reaction vessel, followed by 0.5 mol acetylacetone, then the mixture was heated and stirred at 90° C. for 1.5 h;

2) the temperature was adjusted to 70° C., and a mixed solution of 1.2 mol water and 6 mol n-butanol was added dropwise; the mixture was stirred at 100° C. for 2.5 h after the addition was completed; after the mixture was cooled, the solvent was removed under reduced pressure to obtain the titanium-oxide polymer.

The softening point was 98° C. as measured by the ring-and-ball method; and the number average molecular weight (Mn) was 2930 as measured by the vapor-pressure osmometry.

### Example 19: Preparation of a Glass Fiber Mat-Nano-TiO₂ Photocatalytic Coating Structure

A glass fiber mat (18 cm×9 cm×0.8 cm) (purchased from Hubei Feilihua Quartz Glass Co., Ltd) was subjected to heat treatment in a muffle furnace at 500° C. for 1 h; then the treated glass fiber mat was activated in hot water at 90° C. for 1 h; the activated glass fiber mat was impregnated in an equal volume of the solution of the linear titanium-oxide polymer (obtained in Example 17) in ethanol (at a concentration of 0.8 wt %), and then lifted and pulled, dried, and sintered at 500° C. for 1 h, to obtain the glass fiber mat-nano-TiO₂ photocatalyst coating structure with nano-TiO₂ loading capacity of 10.5 wt % by weight of the glass fiber mat.

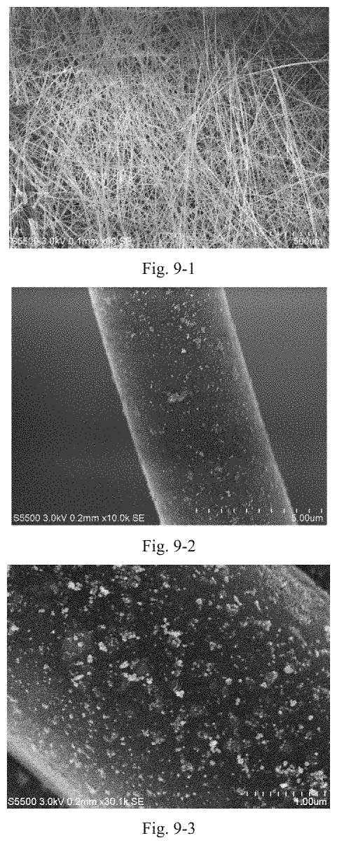

The scanning electron microscopy analysis of the obtained glass fiber mat-nano-TiO₂ photocatalytic coating structure under different magnifications was carried out, and the results are shown in FIG. 9-1, FIG. 9-2 and FIG. 9-3.

The XRD analysis of the obtained glass fiber mat-nano-TiO₂ photocatalytic coating structure was carried out, and the results confirmed that the TiO₂ obtained after heat treatment of the linear titanium-oxide polymer was of anatase phase.

0.5 g of the obtained glass fiber mat-nano-TiO₂ photocatalytic coating structure was added to 50 ml of methyl orange solution (at a concentration of 15 mg/L), and the degradation rate (i.e. the photocatalytic efficiency of the coating structure) of methyl orange was 83.3% after illumination by a 500 W mercury lamp for 2.5 h.

### Comparative Example 1: Catalytic Efficiency of Unsupported TiO₂ Photocatalyst

The unsupported linear titanium-oxide polymer of Example 17 was sintered at 500° C. for 1 h to obtain 50 mg of TiO₂ powder; then the obtained powder was added to 50 ml of methyl orange solution with a concentration of 15 mg/L, and the mixture was illuminated by a 500 W mercury lamp for 2.5 h. The degradation rate of methyl orange was 69.5%.

It can be seen from the comparative example that the photocatalytic efficiency (the degradation rate of methyl orange) of the glass fiber mat-nano-TiO₂ photocatalyst coating structure in Example 19 of the present invention is significantly higher than that of the unsupported TiO₂ powder. This is due to the fact that the glass fiber mat can implement rapid surface enrichment of methyl orange and thus can provide a high concentration environment for the photocatalytic reaction of TiO₂; in addition, the photocatalytic reaction belongs to the first-order reaction, thereby the local high concentration can effectively improve the photocatalytic reaction rate.

### Example 20: The Reusability of a Glass Fiber Mat-Nano-TiO₂ Photocatalytic Coating Structure

The reusability of the obtained glass fiber mat-nano-TiO₂ photocatalyst coating structure was determined as follows: the glass fiber mat-nano-TiO₂ photocatalytic coating structure (0.6517 g) obtained in Example 17 was added to 50 ml of methyl orange solution (at a concentration of 15 mg/L), and the methyl orange solution was illuminated by a 500 W mercury lamp for 2.5 h, and the photocatalytic efficiency (i.e. the degradation rate of methyl orange) was 89.3%. The glass fiber mat-nano-TiO₂ photocatalytic coating structure after photodegradation of methyl orange was washed with deionized water for 5-8 times, and dried at 100° C. Then the photodegradation experiment for the methyl orange solution was carried out again under the same conditions, and the photocatalytic efficiency was calculated. The above operation was repeated 10 times.

In the prior art, the surface of the glass fiber mat-TiO₂ coating structure in which the TiO₂ coating is coated by a binder may adsorb part of methyl orange and impurities after photocatalytic reaction, leading to contamination of the TiO₂ photocatalyst and reduced effective area of photocatalytic reaction. In addition, part of the unsteadily loaded TiO₂ particles may shed off due to washing in the stirring process, such that the photocatalytic activity of the glass fiber mat tends to decrease gradually. After the above operation was repeated 10 times, the photocatalytic efficiency of the glass fiber mat-nano-TiO₂ photocatalytic coating structure of the present invention still remained above 80.2%, indicating that the glass fiber mat-nano-TiO₂ photocatalytic coating structure of the present invention has excellent reusability.

### Example 21: Preparation of a Glass Fiber Mat-Nano-TiO₂ Photocatalyst Coating Structure

A glass fiber mat (18 cm×9 cm×0.8 cm) (purchased from Hubei Feilihua Quartz Glass Co., Ltd) was subjected to heat treatment in a muffle furnace at 550° C. for 30 min; then the treated glass fiber mat was activated in hot water at 80° C. for 1 h; the activated glass fiber mat was impregnated in an equal volume of the solution of the linear titanium-oxide polymer (prepared in Example 18) in ethanol (at a concentration of 1.3 wt %), and then lifted and pulled, dried, and sintered at a high temperature, to obtain thenano-TiO₂ photocatalytic coating structure with TiO₂ loading capacity of 16.7% by weight of the glass fiber mat.

0.5000 g of the above glass fiber mat-nano-TiO₂ photocatalytic coating structure was added to 50 ml of methyl orange solution (at a concentration of 15 mg/L), and the degradation rate was 91.9% after illumination by a 500 W mercury lamp for 2.5 h.

### Example 22: Preparation of a Glass Fiber Mat-Nano-TiO₂ Photocatalytic Coating Structure

A glass fiber mat (18 cm×9 cm×0.8 cm) (purchased from Hubei Feilihua Quartz Glass Co., Ltd) was subjected to heat treatment in a muffle furnace at 550° C. for 1.5 h; then the treated glass fiber mat was activated in hot water at 100° C. for 2 h; the activated glass fiber mat was impregnated in an equal volume of the solution of the linear titanium-oxide polymer (prepared in Example 17) in ethanol (at a concentration of 1.15 wt %), and then lifted and pulled, dried, and sintered at a high temperature, to obtain the glass fiber mat-nano-TiO₂ photocatalytic coating structure with TiO₂ loading capacity of 15.1 wt % by weight of the glass fiber mat.

0.5000 g of the glass fiber mat-nano-TiO₂ photocatalytic coating structure obtained above was added to 50 ml of methyl orange solution (at a concentration of 15 mg/L), and the photocatalytic efficiency (the degradation rate of methyl orange) was 86.8% after illumination by a 500 W mercury lamp for 2.5 h.

The load stability of the glass fiber mat-nano-TiO₂ photocatalytic coating structure obtained above was determined as follows: the obtained glass fiber mat-nano-TiO₂ photocatalytic coating structure was immersed in deionized water by using the method of ultrasonic washing, then subjected to ultrasonic treatment at 40 KHz for 1 h, and then filtered and dried. The load stability of the sample was measured by the change in the mass of the TiO₂ that was loaded effectively. After the first ultrasonic treatment, the weight of TiO₂ was only reduced by 1.15 wt %.

### Example 23: Preparation of a Glass Fiber Mat-Nano-TiO₂ Photocatalytic Coating Structure

A glass fiber mat (18 cm×9 cm×0.8 cm) (purchased from Hubei Feilihua Quartz Glass Co., Ltd) was subjected to heat treatment in a muffle furnace at 450° C. for 2 h; then the treated glass fiber mat was activated in hot water at 90° C. for 1 h; the activated glass fiber mat was impregnated in an equal volume of the solution of the linear titanium-oxide polymer (obtained in Example 18) in ethanol (at a concentration of 2.5 wt %), and then lifted and pulled, dried, and sintered, to obtain the glass fiber mat-nano-TiO₂ photocatalyst coating structure with TiO₂ loading capacity of 32.3 wt % by weight of the glass fiber mat.

0.5000 g of the above glass fiber mat-nano-TiO₂ photocatalytic coating structure was added to 50 ml of methyl orange solution (at a concentration of 15 mg/L), and the degradation rate was 75.9% after illumination by a 500 W mercury lamp for 2.5 h. This is due to the following fact: although the loading rate is high, the TiO₂ particles are agglomerated together, resulting in less effective active centers and less free radicals attracted and thus lower catalytic efficiency.

### Example 24: Preparation of a Glass Fiber Mat-Nano-TiO₂ Photocatalyst Coating Structure

A glass fiber mat (27 cm×27 cm×0.8 cm) (purchased from Hubei Feilihua Quartz Glass Co., Ltd.) was subjected to heat treatment in a muffle furnace at 550° C. for 30 min; then the treated glass fiber mat was activated in hot water at 100° C. for 30 min; the activated glass fiber mat was impregnated in an equal volume of the solution of the titanium-oxide polymer (obtained in Example 1) in ethanol (at a concentration of 0.8 wt %), and then lifted and pulled, dried, and sintered, to obtain the glass fiber mat-nano-TiO₂ photocatalytic coating structure with TiO₂ loading capacity of 10.5 wt % by weight of the glass fiber mat.

0.5000 g of the above glass fiber mat-nano-TiO₂ photocatalytic coating structure was added to 50 ml of methyl orange solution (at a concentration of 15 mg/L), and the degradation rate was 84.1% after illumination by a 500 W mercury lamp for 2.5 h.

The basic principle, primary characteristics and advantages of the present invention have been described above by way of the examples. It should be understood by those skilled in the art that the present invention is not limited to the foregoing examples, and the above examples and the contents described in the specification are merely used for illustrating the principle of the present invention. There will be various variations and modifications of the present invention without departing from the spirit and scope of the present invention.

What is claimed is:

1. A linear titanium-oxide polymer, comprising the following structural formula: 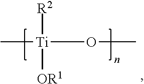
wherein
the R¹ is selected from the group consisting of —C₂H₅, —C₃H₇, —C₄H₉, and —C₅H₁₁;
the R² is OR¹ or a complexing group selected from the group consisting of CH₃COCHCOCH₃ and CH₃COCHCOOC₂H₅, at least 50% of the R² are the complexing group by a total number of the R²;
a number average molecular weight (Mn) of the linear titanium-oxide polymer is 2000-3000, when determined by a vapor-pressure osmometry; and
a solvent-free pure titanium-oxide polymer has a softening point in a range of 90-127° C., when determined by a ring-and-ball method.

2. A method for preparing a linear titanium-oxide polymer, comprising steps of:
1) adding a titanate to a reaction vessel, and adding a chelating agent to the titanate at 50-90° C. to obtain a first mixture, heating and stirring the first mixture for 0.5-1.5 h;
2) adding a mixed solution of water and alcohol dropwise to the first mixture at 50-90° C. to obtain a second mixture, and stirring the second mixture at 80-110° C. for 1.5-4 h after an addition of the mixed solution is completed, cooling the second mixture, then removing a solvent under a reduced pressure to obtain the linear titanium-oxide polymer;
wherein the linear titanium-oxide polymer comprises the following structural formula: 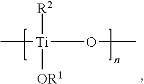
the R¹ is selected from the group consisting of —C₂H₅, —C₃H₇, —C₄H₉, and —C₅H₁₁;
the R² is OR¹ or a complexing group selected from the group consisting of CH₃COCHCOCH₃ and CH₃COCHCOOC₂H₅, at least 50% of the R² are the complexing group by a total number of the R²;
a number average molecular weight (Mn) of the linear titanium-oxide polymer is 2000-3000 when determined by a vapor-pressure osmometry; and
a solvent-free pure titanium-oxide polymer has a softening point in a range of 90-127° C. when determined by a ring-and-ball method.

3. The method for preparing the linear titanium-oxide polymer of claim 2, wherein a molar ratio of the titanate, the chelating agent and the water is 1:(0.5-1.4):(0.8-1.3).

4. The method for preparing the linear titanium-oxide polymer of claim 2, wherein a molar ratio of the water to the alcohol in the mixed solution of water and alcohol is 1:(3-20).

5. The method for preparing the linear titanium-oxide polymer of claim 2, wherein in the step 1), the titanate has a structure of Ti(OR¹)₄, wherein the R¹ of the Ti(OR¹)₄ is selected from the group consisting of —C₂H₅, —C₃H₇, —C₄H₉, and —C₅H₁₁.

6. A nano-TiO₂ coating structure, comprising:
a substrate, and
a nano-TiO₂ coating supported on a surface of the substrate;
wherein
the nano-TiO₂ coating comprises a plurality of nano-TiO₂ particles, an average particle size of the plurality of nano-TiO₂ particles is 10-50 nm; and
a loading capacity of the nano-TiO₂ coating structure is 1.0-100 μg of nano-TiO₂ coating per cubic centimeter of the substrate.

7. The nano-TiO₂ coating structure of claim 6, wherein the loading capacity of the nano-TiO₂ coating structure is 1.0-3 μg of nano-TiO₂ coating per cubic centimeter of the substrate.

8. The nano-TiO₂ coating structure of claim 6, wherein the plurality of nano-TiO₂ particles in the nano-TiO₂ coating are of anatase phase.

9. The nano-TiO₂ coating structure of claim 6, wherein the nano-TiO₂ coating is formed by sintering a solution of a linear titanium-oxide polymer.

10. (canceled)

11. The nano-TiO₂ coating structure of claim 6, wherein the nano-TiO₂ coating is colorless and/or transparent, and a visible light transmittance of the nano-TiO₂ coating is higher than 80%.

12. The nano-TiO₂ coating structure of claim 6, wherein the nano-TiO₂ coating structure has a water contact angle of less than 10°.

13. The nano-TiO₂ coating structure of claim 6, wherein the substrate is in a shape of a plate, a honeycomb, a fiber, a sphere or a hollow sphere, and a shape of the nano-TiO₂ coating varies with the shape of the substrate.

14. (canceled)

15. The nano-TiO₂ coating structure of claim 6, wherein the substrate comprises silicon-based materials, metals, glass, ceramics, and adsorbent materials, or a combination of the silicon-based materials, the metals, the glass, the ceramics, and the adsorbent materials.

16. The nano-TiO₂ coating structure of claim 15, wherein the metals comprise steel plates, aluminum plates, titanium plates, copper plates, zinc plates, foamed nickels, foamed aluminums and aluminum honeycombs; the glass comprises glass sheets, glass fiber cloths, hollow glass microspheres, glass beads, and glass springs; the ceramics comprise hollow ceramic microspheres, ceramic tiles, ceramic plates and honeycomb ceramics; and the adsorbent materials comprise silicon oxide, silica gels, activated carbons, zeolites, and molecular sieves.

17. The nano-TiO₂ coating structure of claim 6, wherein the surface of the substrate is rough, the surface of the substrate comprises a plurality of protrusions and/or a plurality of potholes, wherein outer surfaces of the plurality of protrusions and/or the plurality of potholes are of nanoscale sizes.

18. A method for preparing a nano-TiO₂ coating structure, comprising the steps of:
1) dissolving a linear titanium-oxide polymer in a solvent to prepare a solution, wherein a concentration of the solution is 0.3-2 wt % by titanium;
2) pretreating a surface of a substrate to be coated optionally;
3) applying the solution uniformly on the substrate to obtain a solution-coated substrate, drying and sintering the solution-coated substrate to obtain a nano-TiO₂ coating supported on the substrate;
wherein the linear titanium-oxide polymer in the step 1) comprises a main chain of repeating Ti—O bonds and a plurality of pendant groups of organic groups, and the linear titanium-oxide polymer comprises the following structural formula: 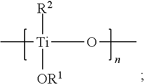
wherein the R¹ is selected from the group consisting of —C₂H₅, —C₃H₇, —C₄H₉, and —C₅H₁₁; the R² is OR¹ or a complexing group selected from the group consisting of CH₃COCHCOCH₃ and CH₃COCHCOOC₂H₅, at least 50% of the R² are the complexing group by a total number of the R²; a number average molecular weight (Mn) of the linear titanium-oxide polymer is 2000-3000 when determined by a vapor-pressure osmometry; and a solvent-free pure linear titanium-oxide polymer has a softening point in a range of 90-127° C. when determined by a ring-and-ball method;
the nano-TiO₂ coating structure comprises the substrate, and the nano-TiO₂ coating supported on the surface of the substrate; wherein the nano-TiO₂ coating comprises a plurality of nano-TiO₂ particles, an average particle size of the plurality of nano-TiO₂ particles is 10-50 nm; and a loading capacity of the nano-TiO₂ coating structure is 1.0-100 μg of nano-TiO₂ coating per cubic centimeter of the substrate.

19. The method for preparing the nano-TiO₂ coating structure of claim 18, wherein the linear titanium-oxide polymer is prepared by a method comprising steps of:
a) adding a titanate to a reaction vessel, and adding a chelating agent to the titanate at 50-90° C. to obtain a first mixture, heating and stirring the first mixture for 0.5-5.0 h;
b) adding a mixed solution of water and alcohol dropwise to the first mixture at 50-90° C. to obtain a second mixture, and stirring the second mixture at 80-110° C. for 1.5-6 h after an addition of the mixed solution is completed, cooling the second mixture, and then removing a solvent under a reduced pressure to obtain the linear titanium-oxide polymer.

20. (canceled)

21. (canceled)

22. The method for preparing the nano-TiO₂ coating structure of claim 18, wherein the nano-TiO₂ coating described in the step 3) is obtained by sintering the solution-coated substrate in air at 450-550° C.

23. A glass fiber mat-nano-TiO₂ photocatalyst coating structure, comprising:
a glass fiber mat substrate, and
a nano-TiO₂ photocatalyst coating supported on a surface of the glass fiber mat substrate;
wherein
the nano-TiO₂ photocatalyst coating comprises a plurality of nano-TiO₂ particles, an average particle size of the plurality nano-TiO₂ particles is 10-50 nm, and
a loading capacity of the nano-TiO₂ photocatalyst coating is 5-30 wt % by weight of the glass fiber mat substrate.

24. The glass fiber mat-nano-TiO₂ photocatalyst coating structure of claim 23, wherein the loading capacity of the nano-TiO₂ photocatalyst coating is 10-20 wt % b weight of the glass fiber mat substrate.

25. The glass fiber mat-nano-TiO₂ photocatalyst coating structure of claim 23, wherein the nano-TiO₂ photocatalytic coating has a thickness of 50-200 nm.

26. (canceled)

27. (canceled)

28. The glass fiber mat-nano-TiO₂ photocatalyst coating structure of claim 23, wherein the plurality of nano-TiO₂ particles in the nano-TiO₂ photocatalyst coating are of anatase phase.

29. The glass fiber mat-nano-TiO₂ photocatalyst coating structure of claim 23, wherein the glass fiber mat substrate has a mass per unit area in a range of 100-500 g/m².
